(19) United States
(12) Patent Application Publication
(10) Pub. No.: US 2006/0098578 A1
(43) Pub. Date: May 11, 2006

(54) System and method for converting autonomous PM data into periodic PM data

(75) Inventors: Arvind R. Mallya, Walnut Creek, CA (US); Bruce Schine, San Leandro, CA (US); Brad Fry, Stockton, CA (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 10/983,522

(22) Filed: Nov. 8, 2004

(51) Int. Cl. H04L 12/26; H04J 3/14; H04J 1/16

(52) U.S. Cl. 370/242; 370/252; 370/250

(57) ABSTRACT

A system for converting autonomous performance monitoring (PM) data into periodic PM data in a network includes a server, a data collector electrically coupled to the server, a plurality of network elements (NEs) electrically coupled to the data collector, and a user database electrically coupled to the server. When connectivity of the system has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database.

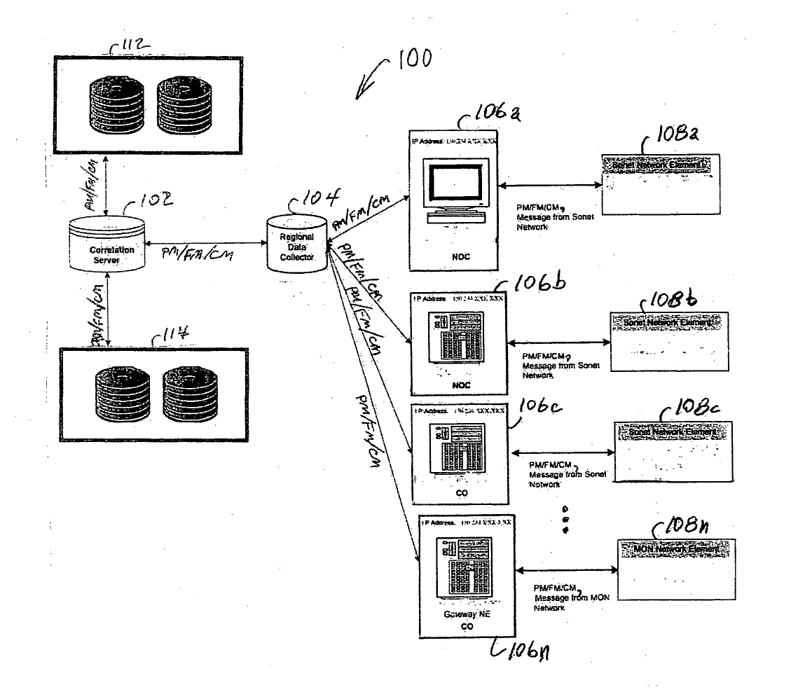

### BACKGROUND OF THE INVENTION

1. Field of the Invention

The present invention relates to a system and a method for converting autonomous performance monitoring (PM) data into periodic PM data.

2. Background Art

When autonomous performance monitoring (PM) data is presented by a network element (NE) to a network controller, the autonomous PM data can be disruptive to normal network operations. Conventional approaches to networks generally fail to provide for converting autonomous PM data into periodic PM data. Further, a network user may wish to have periodically generated PM data such that PM metrics can be generated and reported.

Thus, there exists a need for an improved system and an improved method for converting autonomous performance monitoring (PM) data into periodic PM data. Such an improved system and an improved method may address some or all of the problems and deficiencies of conventional approaches identified above, and provide additional features and advantages as discussed below.

### BRIEF DESCRIPTION OF THE DRAWINGS

The present invention is pointed out with particularity in the appended claims. However, other features of the present invention will become more apparent, and the present invention will be best understood by referring to the following detailed description in conjunction with the accompanying drawing in which:

The FIGURE illustrates an example of a network implemented according to the present invention.

### DETAILED DESCRIPTION OF THE PREFERRED EMBODIMENT(S)

The present invention generally provides new, improved and innovative techniques for converting autonomous performance monitoring (PM) data into periodic PM data. The system and method of the present invention generally provide for time normalization of autonomous PM data to convert the autonomous PM data to respective periodic PM data.

In the description below, the abbreviations, acronyms, terms, etc. may be defined as follows:

ANSI: American National Standards Institute. Founded in 1918, ANSI is a voluntary organization composed of over 1,300 members (including all the large computer companies) that creates standards for the computer industry. In addition to programming languages, ANSI sets standards for a wide range of technical areas, from electrical specifications to communications protocols. For example, FDDI, the main set of protocols for sending data over fiber optic cables, is an ANSI standard. SONET (see below) is also an ANSI standard.

ATM: Asynchronous Transfer Mode. ATM is a network technology based on transferring data in cells or packets of a fixed size. The cell used with ATM is relatively small compared to units used with older technologies. The small, constant cell size allows ATM equipment to transmit video, audio, and computer data over the same network, and assure that no single type of data hogs the line. ATM is a dedicated-connection switching technology that organizes digital data into predetermine byte-size cell units and transmits the cell units over a physical medium using digital signal technology. Individually, cells are processed asynchronously relative to other related cells and are queued before being multiplexed over the transmission path.

Backup: A reserve, substitute, extra, standby, or other resource for use in the event of failure or loss of the original (or primary) resource.

CNM: Customer or Configuration Network Management

CO: Central Office. In telephony, a CO is a telecommunications office centralized in a specific locality to handle the telephone service for that locality. Telephone lines are connected to the CO on a local loop. The CO switches calls between local service and long-distance service. ISDN and DSL signals also channel through the CO.

Correlation: The relationship between two variables during a period of time, especially a relationship that shows a close match between movements of the variables.

DCC: Data Country Code

DNS: Domain Name System (or Service or Server). DNS is an Internet service that translates domain names into IP addresses. Because domain names are alphabetic, they're easier to remember. The Internet however, is really based on IP addresses. Every time a domain name is used, therefore, a DNS service must translate the name into the corresponding IP address. For example, the domain name www.example.com might translate to 198.105.232.4. The DNS system is, in fact, its own network. If one DNS server doesn't know how to translate a particular domain name, it asks another one, and so on, until the correct IP address is returned.

DSL or xDSL: Refers collectively to all types of digital subscriber lines, the two main categories being ADSL and SDSL. Two other types of xDSL technologies are High-data-rate DSL (HDSL) and Very high DSL (VDSL). DSL technologies use sophisticated modulation schemes to pack data onto copper wires. They are sometimes referred to as last-mile technologies because they are used only for connections from a telephone switching station to a home or office, not between switching stations. xDSL is similar to ISDN inasmuch as both operate over existing copper telephone lines (POTS) and both require the short runs to a central telephone office (usually less than 20,000 feet). However, xDSL offers much higher speeds—up to 32 Mbps for upstream traffic, and from 32 Kbps to over 1 Mbps for downstream traffic.

EMS: Enhanced Message Service, an application-level extension to SMS for cellular phones available on GSM, TDMA and CDMA networks. Where GSM is an abbreviation for Global System for Mobile Communications, one of the leading digital cellular systems. GSM uses narrowband TDMA, which allows eight simultaneous calls on the same radio frequency. TDMA is Time Division Multiple Access, a technology for delivering digital wireless service using time-division multiplexing (TDM). TDMA works by dividing a radio frequency into time slots and then allocating slots to multiple calls. In this way, a single frequency can support multiple, simultaneous data channels. TDMA is used by the GSM digital cellular system. CDMA is Code-Division Multiple Access, a digital cellular technology that uses spread-spectrum techniques. Unlike competing systems, such as GSM, that use TDMA, CDMA does not assign a specific frequency to each user. Instead, every channel uses the full available spectrum. Individual conversations are encoded with a pseudo-random digital sequence.

FM: Fault Management

Gateway: A node on a network that serves as an entrance to another network. In enterprises, the gateway is the computer that routes the traffic from a workstation to the outside network that is serving the Web pages. In homes, the gateway is the ISP that connects the user to the internet. In enterprises, the gateway node often acts as a proxy server and a firewall. The gateway is also associated with both a router, which use headers and forwarding tables to determine where packets are sent, and a switch, which provides the actual path for the packet in and out of the gateway.

IP: Internet Protocol. IP specifies the format of packets, also called datagrams, and the addressing scheme. Most networks combine IP with a higher-level protocol called Transmission Control Protocol (TCP), which establishes a virtual connection between a destination and a source. IP by itself is something like the postal system. IP allows a user to address a package and drop the package in the system, but there is no direct link between the user (sender) and the recipient. TCP/IP, on the other hand, establishes a connection between two hosts so that the hosts can send messages back and forth for a period of time.

MAC address: Media Access Control address. A MAC address is a hardware address that uniquely identifies each node of a network. In IEEE 802 networks, the Data Link Control (DLC) layer of the OSI Reference Model is divided into two sublayers: the Logical Link Control (LLC) layer and the Media Access Control (MAC) layer. The MAC layer interfaces directly with the network medium. Consequently, each different type of network medium requires a different MAC layer. On networks that do not conform to the IEEE 802 standards but do conform to the OSI Reference Model, the node address is called the Data Link Control (DLC) address.

Internet: A global network connecting millions of computers. More than 100 countries are linked into exchanges of data, news and opinions. Unlike online services, which are centrally controlled, the Internet is decentralized by design. Each Internet computer, called a host, is independent. Its operators can choose which Internet services to use and which local services to make available to the global Internet community. There are a variety of ways to access the Internet. Most online services, such as America Online, offer access to some Internet services. It is also possible to gain access through a commercial Internet Service Provider (ISP).

ISDN: Integrated Services Digital Network, an international communications standard for sending voice, video, and data over digital telephone lines or normal telephone wires. ISDN supports data transfer rates of 64 Kbps (64,000 bits per second). There are two types of ISDN: Basic Rate Interface (BRI)—consists of two 64-Kbps B-channels and one D-channel for transmitting control information. Primary Rate Interface (PRI)—consists of 23 B-channels and one D-channel (U.S.) or 30 B-channels and one D-channel (Europe). The original version of ISDN employs baseband transmission. Another version, called B-ISDN, uses broadband transmission and is able to support transmission rates of 1.5 Mbps. B-ISDN requires fiber optic cables and is not widely available.

IT: Information Technology, the broad subject concerned with all aspects of managing and processing information, especially within a large organization or company. Because computers are central to information management, computer departments within companies and universities are often called IT departments. Some companies refer to this department as IS (Information Services) or MIS (Management Information Services).

MON: Multiservice Optical Network

Network: A group of two or more computer systems linked together. There are many types of computer networks, including:

local-area networks (LANs): The computers are geographically close together (that is, in the same building).

wide-area networks (WANs): The computers are farther apart and are connected by telephone lines or radio waves.

campus-area networks (CANs): The computers are within a limited geographic area, such as a campus or military base.

metropolitan-area networks MANs): A data network designed for a town or city.

home-area networks (HANs): A network contained within a user's home that connects a person's digital devices.

In addition to these types, the following characteristics are also used to categorize different types of networks:

topology: The geometric arrangement of a computer system. Common topologies include a bus, star, and ring.

protocol: The protocol defines a common set of rules and signals that computers on the network use to communicate. One of the most popular protocols for LANs is called Ethernet. Another popular LAN protocol for PCs is the IBM token-ring network.

architecture: Networks can be broadly classified as using either a peer-to-peer or client/server architecture. Computers on a network are sometimes called nodes. Computers and devices that allocate resources for a network are called servers.

NOC: Network Operations Center, the physical space from which a typically large telecommunications network is managed, monitored and supervised. The NOC coordinates network troubles, provides problem management and router configuration services, manages network changes, allocates and manages domain names and IP addresses, monitors routers, switches, hubs and uninterruptable power supply (UPS) systems that keep the network operating smoothly, manages the distribution and updating of software and coordinates with affiliated networks. NOCs also provide network accessibility to users connecting to the network from outside of the physical office space or campus.

Normalization: To make normal, especially to cause to conform to a standard or norm. To make (for example, variables) regular and consistent, especially with respect to format.

NSAP: Network Service Access Point

OSI: Open System Interconnection. A networking framework for implementing protocols defined by a seven (7) layer model. Control is passed from one layer to the next, starting at the application layer in one station, proceeding to the bottom layer, over the channel to the next station and back up the hierarchy.

Application Layer (Layer 7): This layer (Layer 7) supports application and end-user processes. Communication partners are identified, quality of service is identified, user authentication and privacy are considered, and any constraints on data syntax are identified. Everything at layer 7 is application-specific. Layer 7 provides application services for file transfers, e-mail, and other network software services. Telnet and FTP are applications that exist entirely in the application level. Tiered application architectures are part of this layer (Layer 7).

Presentation Layer (Layer 6): This layer (Layer 6) provides independence from differences in data representation (e.g., encryption) by translating from application to network format, and vice versa. The presentation layer (Layer 6) works to transform data into the form that the application layer can accept. Layer 6 formats and encrypts data to be sent across a network, providing freedom from compatibility problems. Layer 6 is sometimes called the syntax layer.

Session Layer (Layer 5): This layer (Layer 5) establishes, manages and terminates connections between applications. The session layer sets up, coordinates, and terminates conversations, exchanges, and dialogues between the applications at each end. Layer 5 deals with session and connection coordination.

Transport Layer (Layer 4): This layer (Layer 4) provides transparent transfer of data between end systems, or hosts, and is responsible for end-to-end error recovery and flow control. Layer 4 ensures complete data transfer.

Network Layer (Layer 3): This layer (Layer 3) provides switching and routing technologies, creating logical paths, known as virtual circuits, for transmitting data from node to node. Routing and forwarding are functions of layer 3, as well as addressing, internetworking, error handling, congestion control and packet sequencing.

Data Link Layer (Layer 2): At this layer (Layer 2), data packets are encoded and decoded into bits. Layer 2 furnishes transmission protocol knowledge and management and handles errors in the physical layer, flow control and frame synchronization. The data link layer (Layer 2) is divided into two sublayers: The Media Access Control (MAC) layer and the Logical Link Control (LLC) layer. The MAC sublayer controls how a computer on the network gains access to the data and permission to transmit it. The LLC layer controls frame synchronization, flow control and error checking.

Physical Layer (Layer 1): This layer (Layer 1) conveys the bit stream—electrical impulse, light or radio signal—through the network at the electrical and mechanical level. Layer 1 provides the hardware means of sending and receiving data on a carrier, including defining cables, cards and physical aspects. Fast Ethernet, RS232, and ATM are protocols with physical layer components.

OSS: Operational Support System, a generic term for a suite of programs that enable an enterprise to monitor, analyze and manage a network system. The term originally was applied to communications service providers, referring to a management system that controlled telephone and computer networks. The term has since been applied to the business world in general to mean a system that supports an organization's network operations.

Packet: A piece of a message transmitted over a packet-switching network. One of the key features of a packet is that it contains the destination address in addition to the data. In IP networks, packets are often called datagrams.

Packet switching: Protocols in which messages are divided into packets before they are sent. Each packet is then transmitted individually and can even follow different routes to its destination. Once all the packets forming a message arrive at the destination, the packets are recompiled into the original message.

Most modern Wide Area Network (WAN) protocols, including TCP/IP, X.25, and Frame Relay, are based on packet-switching technologies. In contrast, normal telephone service is based on a circuit-switching technology, in which a dedicated line is allocated for transmission between two parties. Circuit-switching is ideal when data must be transmitted quickly and must arrive in the same order in which the data is sent. This is the case with most real-time data, such as live audio and video. Packet switching is more efficient and robust for data that can withstand some delays in transmission, such as e-mail messages and Web pages. ATM attempts to combine the best of both worlds—the guaranteed delivery of circuit-switched networks and the robustness and efficiency of packet-switching networks.

PM: Performance Monitoring or Management

SMS: Systems Management Server, a set of tools from Microsoft that assists in managing PCs connected to a local-area network (LAN). SMS enables a network administrator to create an inventory of all the hardware and software on the network and to store it in an SMS database. Using this database, SMS can then perform software distribution and installation over the LAN. SMS also enables a network administrator to perform diagnostic tests on PCs attached to the LAN.

SONET: Synchronous Optical Network. SONET is a standard for connecting fiber-optic transmission systems. SONET was proposed by Bellcore in the middle 1980s and is now an ANSI standard. SONET defines interface standards at the physical layer (Layer 1) of the OSI seven-layer model. The SONET standard defines a hierarchy of interface rates that allow data streams at different rates to be multiplexed. SONET establishes Optical Carrier (OC) levels from 51.8 Mbps (about the same as a T-3 line) to 2.48 Gbps. Prior rate standards used by different countries specified rates that were not compatible for multiplexing. With the implementation of SONET, communication carriers throughout the world can interconnect their existing digital carrier and fiber optic systems.

TARP: Terminal identifier Address Resolution Protocol

TCP: Transmission Control Protocol. TCP is one of the main protocols in TCP/IP networks. Whereas the IP protocol deals only with packets, TCP enables two hosts to establish a connection and exchange streams of data. TCP guarantees delivery of data and also guarantees that packets will be delivered in the same order in which they were sent.

TL1: Transaction Language 1. TL1 is a subset of the input/output (I/O) messages contained in the International Telecommunications Union (ITU) Man-Machine Language (MML) standards. TL1 is the predominant broadband management interface in North America. TL1 is used for communication between intelligent network elements.

The following alphabetized list of Transaction Language 1 (TL1) messages are, in one example, defined as being appropriate for Synchronous Optical Network (SONET) network element (NE) types and may be implemented in connection with the present invention. The messages in the following list are generally deployed by one or more NE vendors in respective SONET NEs.

SONET: Messages for TL1 NEs

Autonomous Messages

CANC

REPT ALM [MOD2]

REPT ALM ENV

REPT ALM SECU

REPT COND [MOD2]

REPT DBCHG

REPT DGN

REPT DGNDET

REPT EVT [MOD2]

REPT EVT SESSION

REPT EX

REPT LOCL IN

REPT PM [MOD2]

REPT RMV

REPT RST

REPT SW

REPT TRC

Command/Response Messages

ACT-USER

ALW-DGN

ALW-EX

ALW-LPBK

ALW-MSG [MOD]

ALW-PMREPT

ALW-SW [MOD]

ALW-SWDX[MOD]

ALW-SWTOPROTN

ALW-SWTOWKG

CANC-CID-SECU

CANC-USER

CANC-USER-SECU

CPY-MEM

DGN [MOD]

DGN-DET

DLT [Component]

DLT-CID-SECU

DLT-CMD-SECU

DLT-CRS [MOD2]

DLT-FFP [MOD2]

DLT GOS [MOD2]

DLT LLSDCC

DLT-OSACMAP

DLT-RSC-SECU

DLT-LLSDCC

DLT LOG [MOD2]

DLT OSACMAP

DLT-SDCC

DLT-SECU

DLT-SECU-USER, DLT-USER-SECU(STANDARD)

DLT-TADRMAP

DLT-ULSDCC

ED [MOD]

ED-CID-SECU

ED-CMD-SECU

ED-CRS [MOD2]

ED-DAT

ED DFLT SECU

ED-FFP [MOD2]

ED GOS[MOD2]

ED-LLSDCC

ED LOG

ED-OSACMAP

ED-PID

ED-RSC-SECU

ED-SECU

ED SECU PID

ED-SECU-USER ED-USER-SECU (STANDARD)

ED-TADRMAP

ED-ULSDCC

ENT-[Component]

ENT-CID-SECU

ENT-CMD-SECU

ENT-CRS [Component]

ENT-FFP

ENT-LLSDCC

ENT-NDIDMAP

ENT-OSACMAP

ENT-PPG

ENT-RSC-SECU

ENT-SECU

ENT-SECU-USER ENT-USER-SECU (STANDARD)

ENT-TADRMAP

ENT-ULSDCC

EX-SW[MOD]

EXIT-LOCL-RST

INH-AUTORST

INH-CMD

INH-DGN

INH-EX

INH-LPBK

INH-MSG [MOD2]

INH-PMREPT

INH SW

INH-SWDX

INH-SWTOPROTN

INH-SWTOWKG

INIT-LOG

INIT-REG[MOD2]

INIT-SYS

OPR-ACO[MOD2]

OPR-EXT-CONT

OPR-LPBK [MOD2]

OPR-PROTNSW

OPR-SYNCNSW

RLS-EXT-CONT

RLS-LPBK[MOD2]

RLS-PROTNSW

RLS-SYNCNSW

RMV [MOD]

RST[MOD]

RTRV-[MOD]

RTRV-ALM [MOD2]

RTRV-ALM-ENV

RTRV-AO

RTRV-ATTR[MOD]

RTRV-ATTR-CONT

RTRV-ATTR-ENV

RTRV-ATTR-SECULOG

RTRV-AUDIT-SECULOG

RTRV-CID

RTRV-CID-SECU

RTRV-CMD-SECU

RTRV-COND [MOD2]

RTRV COND ENV

RTRV-CRS [Component]

RTRV-DFLT-SECU

RTRV-DGNSCHED

RTRV-EXSCHED

RTRV EXT CONT

RTRV-FFP [MOD2]

RTRV GOS

RTRV-HDR

RTRV-LLSDCC

RTRV-LOG

RTRV-MEMSTAT [MOD]

RTRV OPT [MOD]

RTRV-OSACMAP

RTRV-PM [MOD]

RTRV-PMMODE

RTRV-PMSCHED[MOD]

RTRV-PTHTRC [MOD]

RTRV-PROTLOG

RTRV-PROTNSW

RTRV-RSC-SECU

RTRV-SECU

RTRV-USER-SECU RTRV-SECU-USER

RTRV-TADRMAP

RTRV-TCA

RTRV-TH

RTRV-ULSDCC

RTRV-USER

SCHED-EX

SCHED-PMREPT

SET-ACO

SET-ATTR [MOD2]

SET-ATTR-CONT

SET-ATTR-ENV

SET-ATTR-SECUALM

SET-ATTR-SECUDFLT

SET-ATTR-SECULOG

SET-PMMODE

SET-SID

SET-SYNCN

SET-TH

STA-LOCL-RST

STA-DGN

STA-LOG

STA-TRC

STP-DGN

STP-LOG

STP-TRC

SW-DX [MOD]

SW-TOPROTN

SW-TOWKG

However, any appropriate messages may be implemented to meet the design criteria of a particular application.

According to the present invention, a system for converting autonomous performance monitoring (PM) data into periodic PM data in a network is provided. The system comprises a server, a data collector electrically coupled to the server, a plurality of network elements (NEs) electrically coupled to the data collector, and a user database electrically coupled to the server. When connectivity of the system has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database.

Also according to the present invention, a method of converting autonomous performance monitoring (PM) data into periodic PM data in a network is provided. The method comprises electrically coupling a data collector to a server, electrically coupling a plurality of network elements (NEs) to the data collector, and electrically coupling a user database to the server to form a system. When connectivity of the system has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database.

Further, according to the present invention, a network for converting autonomous performance monitoring (PM) data into periodic PM data is provided. The network comprises a server, a data collector electrically coupled to the server, a plurality of network elements (NEs) electrically coupled to the data collector, and a user database electrically coupled to the server. When connectivity of the network has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database.

Further, when the connectivity of the network has been established for the predetermined time duration and a new value for the signal has not been autonomously presented to the data collector during the predetermined time duration, the current value for the signal in the server remains unchanged, and the server tags the current value with the time for the end of the predetermined interval and presents the tagged current value to the at least one user application in the user database. Further, when connectivity of the network has been established for less than the predetermined time duration, and a new value for the signal has been presented autonomously after the latest loss of connectivity in the network, the value of the signal in the data collector is set to the new value, the data collector presents the new value to the server, and the server tags the new value with the time for the end of the predetermined interval and presents the tagged new value to at least one user application in the user database.

Yet further, when the connectivity of the network has been established for less than the predetermined time duration, a new value for the signal has not been presented autonomously after the latest loss of connectivity in the network, and at the end of the predetermined time duration the status of the connectivity is “UP”, the server presents a command to retrieve the most recent predetermined time interval current value, the current value in the server is set to the most recent current value, and the server tags the current value with the time for the end of the predetermined interval and presents the tagged current value to the at least one user application in the user database. Yet further, when the connectivity of the network has been established for less than the predetermined time duration, a new value for the signal has not been presented autonomously after the latest loss of connectivity in the network, and at the end of the predetermined time duration the status of the connectivity is “DOWN”, the current value in the server is set to a value for indication of missing data, the server tags the current value with the time for the end of the predetermined interval and presents the tagged current value to the at least one user application in the user database.

The above features, and other features and advantages of the present invention are readily apparent from the following detailed descriptions thereof when taken in connection with the accompanying drawings.

With reference to the FIGURE, the preferred embodiments of the present invention will now be described in detail. The present invention may be advantageously implemented in connection with a network. In one example, the present invention may be implemented in connection with a telecommunications network. However, the present invention may be implemented in connection with any appropriate network to meet the design criteria of a particular application.

Referring to the FIGURE, a system 100 illustrating an example of a network implemented according to the present invention is shown. The network (or system) 100 generally comprises a correlation server 102, a regional data collector 104, at least one network work station (or gateway) 106 (e.g., work stations 106a-106n), at least one network element (NE) 108 (e.g., NEs 108a-108n), at least one correlation database 112, and at least one user database 114. The network 100 is generally implemented in connection with (i.e., via) the Internet. In one example, the network 100 may be implemented as a telecommunications network having optical interconnections (e.g., links) between at least some of the network elements (NEs). In one example, the system 100 may comprise Synchronous Optical Network Customer or Configuration Network Management (SONET/CNM) Data Collection and Network Elements having a True Transaction Language 1 (TL1) Transmission Control Protocol/Internet Protocol (TCP/IP) session capable architecture.

The server 102 is generally electrically coupled to the at least one other database 112 (e.g., a correlation database) such that information (e.g., data) may be accessed to provide correlation of at least one of performance monitoring or management (PM) data, fault management (FM) data, and configuration management (CM) data related to operation of the network 100 using the server 102. The server 102 generally comprises at least one processor or controller to perform at least one correlation operation (i.e., routine, algorithm, process, blocks, steps, method, etc.).

In one example, the server 102 may determine (e.g., calculate, compare, etc.) correlation relative to prior performance of the network 100. In another example, the correlation may be determined relative to networks (or systems) other than the system 100. However, correlation may be performed relative to any appropriate information to meet the design criteria of a particular application.

The server 102 is generally electrically coupled to at least one other database 114 (e.g., a user application database) in addition to the at least one correlation database 112 such that information (e.g., data) may be directly fed (i.e., transmitted, broadcast, sent, presented, exchanged, received, etc.) periodically to and from the server 102 (i.e., the server 102 may provide time normalization). The server 102 is generally electrically coupled to the data collector 104.

The data collector 104 is generally electrically coupled to the gateways and work stations 106. Each of the gateways and work stations 106 is generally electrically coupled to a respective NE 108 (e.g., the work station 106a may be electrically coupled to the NE 108a, the work station 106b may be electrically coupled to the NE 108b, an so on, and the gateway 108n may be electrically coupled to the NE 108n). The work stations and gateways 106 are generally implemented as controllers that have respective Internet protocol (IP) addresses and that control the respective NE 108.

Each NE 108 generally exchanges (i.e., presents and receives) at least one message (e.g., a respective signal, PM/FM/CM) autonomously (i.e., independently of time, non-periodically, when generated, at random times, etc.) to and from the respective controller 106. The connectivity between the controller 106a and the NE 108a, between the controller 106b and the NE 108b, and between the controller 106c and the NE 108c may be implemented via a SONET. The connectivity between the controller 106n and the NE 108n may be implemented via a Multiservice Optical Network (MON). However, the connectivity between controllers 106 and respective NEs 108 may be implemented as any appropriate network architecture to meet the design criteria of a particular application.

The work stations and gateways 106 may autonomously exchange the at least one message (or signal PM/FM/CM) to and from the collector 104. The collector 104 generally collects (gathers) the at least one message (or signal PM/FM/CM), and may autonomously exchange the at least one message PM/FM/CM to and from the server 102. In one example, the server 102 may periodically present the data contained in the message PM/FM/CM to the user database 114 (i.e., the correlation server 102 generally provides time normalization to the message PM/FM/CM). In another example, the server 102 generally correlates the data contained in the message PM/FM/CM in relation to data stored in the database 112, and periodically present the correlated version of the data contained in the message PM/FM/CM to the user database 114.

In one example, the controller 106a may be implemented as a Fujitsu NetSmart Workstation. The controller 106a may be implemented as (e.g., configured to operate as) a Network Operations Center (NOC) controller. The controller 106b may be implemented as a Fujitsu NetSmart Workstation. The controller 106b may be implemented as a NOC controller. The controller 106c may be implemented as one of a Nortel NE OPC and NPx controller. The controller 106c may be implemented as a Central Office (CO) controller. The controller 106n may be implemented as a Nortel Optera 5200 Gateway NE controller. The controller 106n may be implemented as a Central Office (CO) controller. However, the controllers 106 may be implemented as any appropriate network element and gateway controllers to meet the design criteria of a particular application.

In one example, the NE 108a may be implemented as one of a Fujitsu FLM 150, 600 and 2400 and a Fujitsu Flash 192. The NE 108b may be implemented as one of a Fujitsu Flashware 4300 and 4500. The NE 108c may be implemented as one of a Nortel OC-12 TBM, OC-48, OC-48 Lite, OC-192, and Optera 3300, 3400, and 3500. The NE 108n may be implemented as a Nortel Optera 5200. The NEs 108a, 108b and 108c may be implemented as SONET NEs and the NE 108n may be implemented as a MON element. However, the NEs 108 may be implemented as any appropriate network element to meet the design criteria of a particular application.

The NEs 108 (e.g., the Nortel and Fujitsu network elements) are generally connected directly to the gateway elements 106 (e.g., the OPC, NPx and the GNE 106) and indirectly to each other via the gateway 104 (e.g., a Fujitsu Netsmart EMS northbound TL1 gateway).

The regional data collector 104 generally initiates the true (i.e., not pseudo, not quasi, etc.) TCP/IP sessions with the SONET/MON network elements 108. When the data (e.g., the signals PM/FM/CM) are retrieved from the NEs 108 via the controllers 106, and autonomously reported and collected (e.g., presented to the correlation server 102), further correlation is done (e.g., data related to the correlation operation may be retrieved from other databases, not shown) and forwarded to the appropriate application servers (e.g., other servers having appropriate databases) for direct data feed and GUI access to the customers. In one example, CNM SONET/MON data collection is generally initiated on the following network elements and respective software release.

(i). Nortel S/DMS OC-12 TBM Release 14.0 and the OC-48 Classic Release 16.1 (future Release 17.0) using the Preside EMS release 9.1.1a and subsequent software releases

(ii). Nortel OPTera Metro 3100 release 4.00, Optera Metro Release 3300 Release 7.02, 3400 Release 7.02, OPTera Metro 3500 Release 10.1

(iii). Nortel Optera 5100/5200 Release 5.0 and subsequent DWDM System software releases

(iv). Nortel Connect DX OC-192 System Release 3.03 and subsequent releases

(v). Fujitsu FLM 150 R10P/R, FLM 600 R11R, FLM 2400 R9.2R/R9.4BR and subsequent release supported by Netsmart R2.1.2; FLM 150 R15.2S, FLM 600 R15.2S, FLM 2400 R1.3S/BS and Flash OC-192 R5.2.

(vi). Fujitsu Flashwave 4300 OC-3/OC-12/OC-48 Release 3.3 and Flashwave 4500 OC-12/OC-48/OC-192 Release 2.1.2 and subsequent releases, supported by Netsmart R2.1.2 and subsequent releases

(vii). Cisco 15454 R4.1 and subsequent releases, supported by CTM R4.1 and subsequent releases.

The present invention is generally directed to a system and method for converting autonomous Performance Monitoring Data (PM data, e.g., the at least one message PM/FM/CM) from the at least one network element (NE) 108 using true TCP/IP connectivity to the various, respective on board controllers 106 into periodic data via a true TCP/IP session. PM Data generally refers to Transaction Language 1 (TL1) where TL1 is a subset of the input/output (I/O) messages (or signals) contained in the International Telecommunications Union (ITU) Man-Machine Language (MML) standards. The periodic data may be correlated.

The PM data may be used for Customer Network Management (CNM) applications. The TL1 generally provides a standard set of messages that can be used for communicating between operating systems and NEs, and personnel and NEs. Processes (e.g., operations such as surveillance, memory administration, and test access, and the like) may use short messages to cause (i.e., generate) specific actions at the far end (e.g., at customer locations via customer applications that may be stored in the database 114). Transactions may include the initiation and execution of the respective messages.

In one example (i.e., Fujitsu PM data) may be implemented as follows for Input Syntax and output Syntax.

Input Syntax

RTRV-PM-EQPT:TID:AID:CTAG::MONTYPE,MONLEV,LOCN, DIRN,TMPER,,,INDEX;

Example: RTRV-PM-EQPT:FUJITSU:ALL:CTAG::ALL,NA,NEND,NA,,,,0;

TID

The TID (optional parameter) identifies the target system where the command is directed and is usually a minimum of 7 and a maximum of 20 alphanumeric characters.

CTAG

The correlation tag is composed of one to six ASCII characters.

Aid

IFA2-1 through IFA2-20

SCA2-1

SCA2-2

Null (ALL)

Montype

Monitor type is generally the type of parameter being monitored. Only ALL or null (default) can be generally used.

MONLEV

The monitor level default is not applicable (NA) and null is also a valid value.

LOCN

LOCN is the parameter that indicates where the condition is being detected. NEND and null are the valid values.

DIRN

This parameter indicates the direction of the condition. NA and null are valid values.

TMPER

Time period indicates the time period for the PM information. The valid value for TMPER is null.

Index

Index specifies the register to retrieve. The only valid value is zero (default), because there is no history data for equipment.

Response Format PM Data (Output Syntax)

Normal Response

SID DATE TIME

M CTAG COMPLD

“AID:MONTYPE,MONVAL,VLDTY,LOCN,DIRN, TMPER,MONDAT,MONTM,INDEX”

No Data Response

SID DATE TIME

M CTAG COMPLD

/*No PM Data for Input Condition*/

MONVAL

Monitoring value is the count retrieved.

VLDTY

The value for validity is TRUE, which represents a PM count that has not been initialized during the TMPER.

MONDAT

Monitoring date indicates the monitoring date (month and day) of the PM data, and is specified as mm-dd.

MONTM

Monitoring time indicates the monitoring time (hour and minute) of the PM data, and is specified as hh-mm.

However, any appropriate syntax may be implemented to meet the design criteria of a particular application.

According to the present invention, a True TL1 TCP/IP session may be initiated by the server 102 (e.g., using the data collector 104 and the controller 106) to retrieve and periodically present at least one autonomous message (e.g., the signal PM/F/CM) from at least one NE 108.

In one example, there are five (5) possible cases for the time normalization of autonomous PM data, and the system and method of the present invention generally provide for converting the autonomous PM data into periodic PM data.

In the first case, connectivity to the SONET Ring NODE (e.g., connectivity of the system 100 and, in particular, connectivity of the controllers and gateways 106) has been up (i.e., established) for a predetermined time duration, and a new value has been sent (e.g., the signal MP/FM/CM has been presented) autonomously during the predetermined time duration. In one example, the predetermined time duration (or interval) may nominally (i.e., essentially, approximately, substantially, etc.) be the last 15 minutes, preferably the last 5 to 25 minutes, and most preferably the last 10 to 20 minutes. However, the predetermined time duration may be any appropriate nominal value and range to meet the design criteria of a particular application.

When the connectivity to the SONET Ring has been established for the predetermined time duration, and a new value for the signal MP/FM/CM has been presented autonomously during the predetermined time duration, the Current Value (i.e., the value of the message or signal PM/FM/CM) in the data collector 104 is generally set to the new value. The correlation server 102 generally sends (i.e., presents, transmits, etc.) the Current Value via the message PM/FM/CM to at least one user application at the at least one database 114 tagged with the time for the end of the predetermined (e.g., 15 minute) interval. That is, the correlation server 102 generally receives the autonomously generated signal PM/FM/CM from the collector 104 and periodically presents the signal PM/FM/CM to at least one of the databases 112 and 114.

In the second case, connectivity to the SONET Ring NODE (e.g., connectivity of the system 100) has been established for the predetermined time duration. However, a new value for the message or signal PM/FM/CM has not been sent autonomously during the predetermined time duration. The Current Value for the signal MP/FM/CM in the correlation server 102 generally remains unchanged. The correlation server 102 may send the Current Value via the message PM/FM/CM to a user application in the at least one database 114 tagged with the time for the end of the predetermined (e.g., 15 minute) interval.

In the third case, connectivity to SONET Ring NODE (e.g., connectivity of the system 100) has been established for less than the predetermined time duration, and a new value has been sent (e.g., the signal MP/FM/CM has been presented) autonomously after the latest loss of connectivity in the system 100. The Current Value (i.e., the value of the message or signal PM/FM/CM) in the data collector 104 is generally set to the new value. The correlation server 102 may send the Current Value via the message PM/FM/CM to at least one user application in the at least one database 114 tagged with the time for the end of the predetermined (e.g., 15 minute) interval.

In the fourth case, connectivity to SONET Ring NODE (e.g., connectivity of the system 100) has been established for less than the predetermined time duration, and a new value has not been sent (e.g., the signal MP/FM/CM has not been presented) autonomously after the latest loss of connectivity in the system 100. At the end of the predetermined (e.g., 15 minute) interval, the status of the connectivity to the NODE may be “UP” (i.e., on).

The server 102 may issue (present) a command (control signal) to perform a RTRV-PM to retrieve the most recent predetermined time interval (e.g., 15 minute) bucket (message PM/FM/CM from the NEs 108) on the SONET Ring NODE. The Current Value in the correlation server 102 may be set to the value of the most recent message PM/FM/CM. The correlation server 102 generally sends the Current Value via the most recent message PM/FM/CM to at least one user application in the at least one database 114 tagged with the time for the end of the predetermined (e.g., 15 minute) interval.

In the fifth case, connectivity to SONET Ring NODE (e.g., connectivity of the system 100) has been established for less than the predetermined time duration, and a new value has not been sent (e.g., the signal MP/FM/CM has not been presented) autonomously after the latest loss of connectivity in the system 100. At the end of the predetermined (e.g., 15 minute) interval, the status of the connectivity to the SONET Ring NODE may be “DOWN” (i.e., off).

In one example, the Current Value in the correlation server 102 may be set to the value=NO DATA. However, the Current Value in the correlation server 104 may be set to any appropriate value implemented by a respective user application for indication of missing data. The correlation server 102 generally sends the Current Value via the message PM/FM/CM to at least one user application in the at least one database 114 tagged with the time for the end of the predetermined (e.g., 15 minute) interval.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for converting autonomous performance monitoring (PM) data into periodic PM data in a network, the system comprising:
a server;
a data collector electrically coupled to the server;
a plurality of network elements (NEs) electrically coupled to the data collector; and
a user database electrically coupled to the server, wherein when connectivity of the system has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database.

2. The system of claim 1 wherein, when the connectivity of the system has been established for the predetermined time duration and a new value for the signal has not been autonomously presented to the data collector during the predetermined time duration, the current value for the signal in the server remains unchanged, and the server tags the current value with the time for the end of the predetermined interval and presents the tagged current value to the at least one user application in the user database.

3. The system of claim 1 wherein, when connectivity of the system has been established for less than the predetermined time duration, and a new value for the signal has been presented autonomously after the latest loss of connectivity in the system, the value of the signal in the data collector is set to the new value, the data collector presents the new value to the server, and the server tags the new value with the time for the end of the predetermined interval and presents the tagged new value to at least one user application in the user database.

4. The system of claim 1 wherein, when the connectivity of the system has been established for less than the predetermined time duration, a new value for the signal has not been presented autonomously after the latest loss of connectivity in the system, and at the end of the predetermined time duration the status of the connectivity is “UP”, the server presents a command to retrieve the most recent predetermined time interval current value, the current value in the server is set to the most recent current value, and the server tags the current value with the time for the end of the predetermined interval and presents the tagged current value to the at least one user application in the user database.

5. The system of claim 1 wherein, when the connectivity of the system has been established for less than the predetermined time duration, a new value for the signal has not been presented autonomously after the latest loss of connectivity in the system, and at the end of the predetermined time duration the status of the connectivity is “DOWN”, the current value in the server is set to a value for indication of missing data, the server tags the current value with the time for the end of the predetermined interval and presents the tagged current value to the at least one user application in the user database.

6. The system of claim 1 further comprising at least one correlation database having correlation information related to operation of the system stored therein, wherein the server is electrically coupled to the at least one correlation database such that the correlation information is accessed by the server, and the server comprises at least one processor or controller to perform at least one correlation operation between current value of the signal and the correlation information.

7. The system of claim 1 wherein the network is implemented as at least one of a synchronous optical network (SONET), a Multiservice Optical Network (MON), and a combination of a SONET and a MON.

8. The system of claim 1 wherein the connectivity is true TCP/IP connectivity and the signal is communicated using Transaction Language 1 (TL1) where TL1 is a subset of the input/output (I/O) messages contained in the International Telecommunications Union (ITU) Man-Machine Language (MML) standards.

9. The system of claim 1 wherein the predetermined time duration is substantially the last 15 minutes, preferably the last 5 to 25 minutes, and most preferably the last 10 to 20 minutes.

10. The system of claim 1 wherein a respective controller is electrically coupled to each NE and to the data collector, and the controller presents the signal to the data collector.

11. A method of converting autonomous performance monitoring (PM) data into periodic PM data in a network, the method comprising:
electrically coupling a data collector to a server;
electrically coupling a plurality of network elements (NEs) to the data collector; and
electrically coupling a user database to the server to form a system, wherein when connectivity of the system has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database.

12. The method of claim 11 wherein, when the connectivity of the system has been established for the predetermined time duration and a new value for the signal has not been autonomously presented to the data collector during the predetermined time duration, the current value for the signal in the server remains unchanged, and the server tags the current value with the time for the end of the predetermined interval and presents the tagged current value to the at least one user application in the user database.

13. The method of claim 11 wherein, when connectivity of the system has been established for less than the predetermined time duration, a new value for the signal has been presented autonomously after the latest loss of connectivity in the system, the value of the signal in the data collector is set to the new value, the data collector presents the new value to the server, and the server tags the new value with the time for the end of the predetermined interval and presents the tagged new value to at least one user application in the user database.

14. The method of claim 11 wherein, when the connectivity of the system has been established for less than the predetermined time duration, a new value for the signal has not been presented autonomously after the latest loss of connectivity in the system, and at the end of the predetermined time duration the status of the connectivity is “UP”, the server presents a command to retrieve the most recent predetermined time interval current value, the current value in the server is set to the most recent current value, and the server tags the current value with the time for the end of the predetermined interval and presents the tagged current value to the at least one user application in the user database.

15. The method of claim 11 wherein, when the connectivity of the system has been established for less than the predetermined time duration, a new value for the signal has not been presented autonomously after the latest loss of connectivity in the system, and at the end of the predetermined time duration the status of the connectivity is “DOWN”, the current value in the server is set to a value for indication of missing data, the server tags the current value with the time for the end of the predetermined interval and presents the tagged current value to the at least one user application in the user database.

16. The method of claim 11 further comprising electrically coupling at least one correlation database having correlation information related to operation of the system stored therein to the server such that the correlation information is accessed by the server, and the server comprises at least one processor or controller to perform at least one correlation operation between current value of the signal and the correlation information.

17. The method of claim 11 wherein the network is implemented as at least one of a synchronous optical network (SONET), a Multiservice Optical Network (MON), and a combination of a SONET and a MON.

18. The method of claim 11 wherein the connectivity is true TCP/IP connectivity and the signal is communicated using Transaction Language 1 (TL1) where TL1 is a subset of the input/output (I/O) messages contained in the International Telecommunications Union (ITU) Man-Machine Language (MML) standards.

19. The method of claim 11 wherein the predetermined time duration is substantially the last 15 minutes, preferably the last 5 to 25 minutes, and most preferably the last 10 to 20 minutes.

20. A network for converting autonomous performance monitoring (PM) data into periodic PM data, the network comprising:
a server;
a data collector electrically coupled to the server;
a plurality of network elements (NEs) electrically coupled to the data collector; and
a user database electrically coupled to the server, wherein
when connectivity of the network has been established for at least a predetermined time duration, and a new value for a signal related to at least one of system performance monitoring, fault monitoring and configuration management has been presented autonomously during the predetermined time duration by at least one of the NEs, the data collector presents the new value to the server, and the server tags the new value with the time for the end of the predetermined interval and presents the tagged new value to at least one user application in the user database;
when the connectivity of the network has been established for the predetermined time duration and a new value for the signal has not been autonomously presented to the data collector during the predetermined time duration, the current value for the signal in the server remains unchanged, and the server tags the current value with the time for the end of the predetermined interval and presents the tagged current value to the at least one user application in the user database;
when connectivity of the network has been established for less than the predetermined time duration, and a new value for the signal has been presented autonomously after the latest loss of connectivity in the network, the value of the signal in the data collector is set to the new value, the data collector presents the new value to the server, and the server tags the new value with the time for the end of the predetermined interval and presents the tagged new value to at least one user application in the user database;
when the connectivity of the network has been established for less than the predetermined time duration, a new value for the signal has not been presented autonomously after the latest loss of connectivity in the network, and at the end of the predetermined time duration the status of the connectivity is “UP”, the server presents a command to retrieve the most recent predetermined time interval current value, the current value in the server is set to the most recent current value, and the server tags the current value with the time for the end of the predetermined interval and presents the tagged current value to the at least one user application in the user database; and
when the connectivity of the network has been established for less than the predetermined time duration, a new value for the signal has not been presented autonomously after the latest loss of connectivity in the network, and at the end of the predetermined time duration the status of the connectivity is “DOWN”, the current value in the server is set to a value for indication of missing data, the server tags the current value with the time for the end of the predetermined interval and presents the tagged current value to the at least one user application in the user database.
